(19) United States
(12) Patent Application Publication
(10) Pub. No.: US 2017/0302099 A1
(43) Pub. Date: Oct. 19, 2017

(54) BAG WITH WIRELESS CHARGING APPARATUS

(71) Applicants: Stanley Wayne Bolden, Shreveport, LA (US); Yolanda Ashley Bolden, Shreveport, LA (US)

(72) Inventors: Stanley Wayne Bolden, Shreveport, LA (US); Yolanda Ashley Bolden, Shreveport, LA (US)

(21) Appl. No.: 15/488,883

(22) Filed: Apr. 17, 2017

Related U.S. Application Data
(60) Provisional application No. 62/324,323, filed on Apr. 18, 2016.

(51) Int. Cl. H02J 7/02; H02J 7/00; A45F 3/04; A45C 13/02; A45C 1/02; A45F 3/00

(52) U.S. Cl. CPC H02J 7/025; H02J 7/0047; H02J 7/0044; A45C 1/02; A45F 3/04; A45C 13/02; A45F 2003/001

(57) ABSTRACT

A wireless charging apparatus. The wireless charging apparatus includes a bag having an internal compartment. A pocket sized to receive a mobile device is formed within the internal compartment. A charging station is secured within the bag adjacent to the pocket. The charging station is operable to charge the mobile device when the mobile device is disposed within the pocket. A battery is secured within the bag and provides power to the charging station.

### CROSS-REFERENCE TO RELATED APPLICATION

This application claims the benefit of priority of U.S. provisional application No. 62/284,283, filed Apr. 18, 2016, the contents of which are herein incorporated by reference.

### BACKGROUND OF THE INVENTION

The present subject matter relates generally to systems for charging a personal electronic device.

People rely heavily on their mobile devices, particularly their cellular phones. However, the battery life of the mobile devices is fairly limited. For example, with respect to a mobile phone, the battery may last two to four hours in a talk mode, and two days in standby mode. Often, portable electronic devices stop functioning due to an inadequate battery lifetime, leaving a user feeling stranded without any means of communication. In addition, beyond inconvenience, the lack of battery power may be dangerous in emergency situations or in remote areas.

The conventional method of charging mobile devices typically involves physically plugging the mobile device into a power outlet using a power cord. However, power outlets are sometimes difficult to find, such as in a restaurant or when the user is in transit. Further, the user may not be able to remain at the location of the power outlet for the time required for the mobile device to recharge. In other words, many current charging methods are stationary and do not allow a user to charge his mobile device when a power outlet is not available.

Accordingly, there is a need for systems and methods directed to charging personal electronic devices without relying on stationary power sources and while the user is in transit.

### SUMMARY OF THE INVENTION

In one aspect of the present invention, a wireless charging apparatus comprises: a bag comprising an internal compartment, wherein a pocket sized to receive a mobile device is formed within the internal compartment; a charging station secured within the bag adjacent to the pocket, wherein the charging station is operable to charge the mobile device when the mobile device is disposed within the pocket; and a battery secured within the bag and providing power to the charging station.

These and other features, aspects and advantages of the present invention will become better understood with reference to the following drawings, description and claims.

### BRIEF DESCRIPTION OF THE DRAWINGS

FIG. 1 is a schematic view of an embodiment of the present invention used with a purse;

FIG. 2 is a schematic view of an embodiment of the present invention used with a backpack; and

FIG. 3 is a perspective view of an embodiment of the present invention shown outside of a bag.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a rechargeable fashion accessory. The present invention may include a fashionable purse, a fashionable backpack, a fashionable travel bag and luggage, a fashionable tote bag and briefcase. The present invention is a discreet rechargeable device made within the everyday fashion accessories of an individual's ensemble located under the interior lining of the fashionable bag. The device includes of a small rechargeable battery power source inside a fireproof fabric sleeve. The rechargeable battery source is connected to a small USB power bank circuit board and power port with three small LED lights to indicate the level of power in the charger and also contains a mini GPS tracking PCB circuit board.

The small wireless charging module connected to the USB power bank circuit board and battery enables an individual to recharge their mobile devices with or without a power cord and has the battery power source located in a flat position at the base of the fashionable purse backpack or mobile device carrying case. The USB power bank circuit board and wireless charging module is attached to the interior wall of the fashionable accessory under the interior lining of the fashion accessory, thus remaining unseen and out of sight. This allows the individual the freedom to recharge their mobile devices safely and discreetly while on the go, traveling to meetings at work or at play without being detected by others.

The USB power bank circuit board also has a power port for recharging the rechargeable power source inside the fashion accessory with a power cord as the wireless charging module enables an individual to recharge their rechargeable power source and mobile devices without a power cord. The USB power bank circuit board also has a mini GPS tracking PCB circuit board allowing an individual to track their lost or stolen rechargeable fashionable purse backpack tote bag etc. by using the mobile application tracking service on their mobile device. The mini GPS tracking PCB circuit board also serves as an important locator tool for kid's, teens and adults in emergency situations who are reasonably late, lost or in danger. The rechargeable fashion purse backpack mobile device carrying case or luggage can be constructed of fabric, leather, plastic, vinyl rubber, cardboard, wood, metal or any combination thereof and comes in all shapes sizes and colors to blend in with an individual's daily attire.

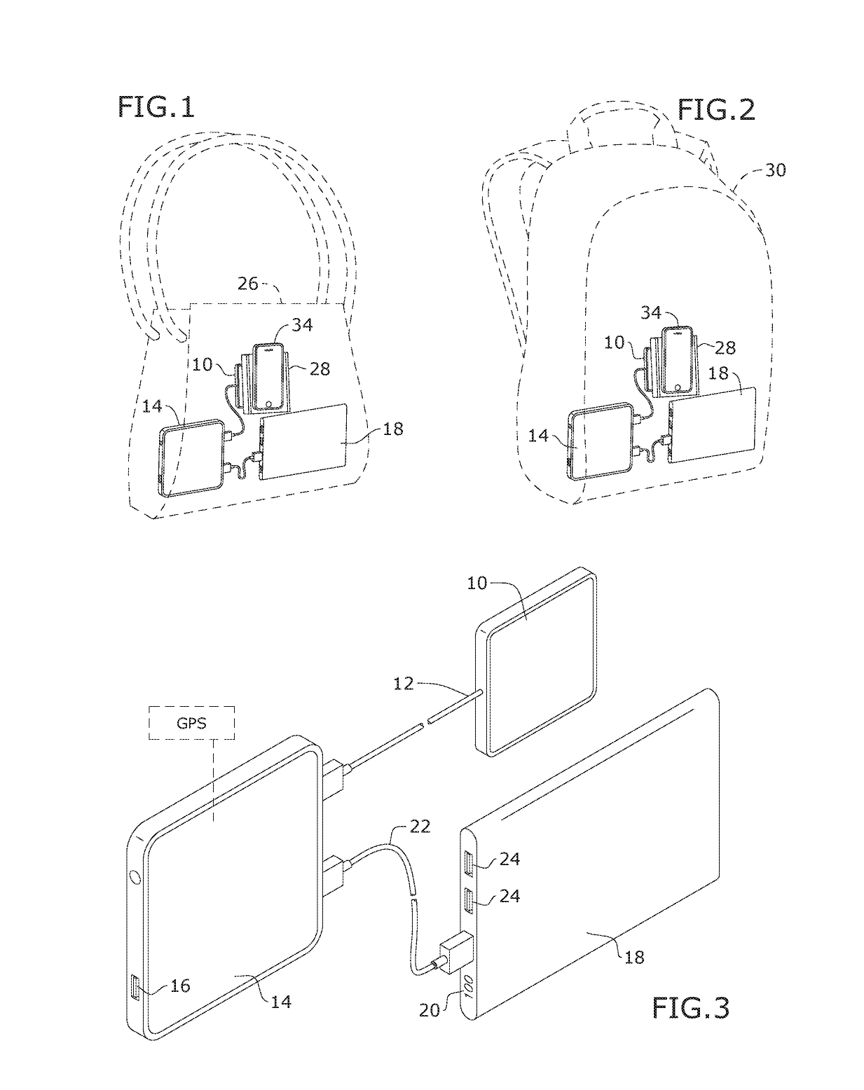

Referring to FIGS. 1 through 3, the present invention includes a wireless charging apparatus. The wireless charging apparatus includes a bag 26, 30 having an internal compartment. A pocket 28 sized to receive a mobile device 34 is formed within the internal compartment. The mobile device 34 may be a mobile phone, an MP3 player and the like. A charging station 10 is secured within the bag adjacent to the pocket 28. The charging station 10 is operable to charge the mobile device 34 when the mobile device 34 is disposed within the pocket 28. A battery 18 is secured within the bag 26, 30 and provides power to the charging station 10.

The charging station 10 may use inductive charging. Inductive charging uses an electromagnetic field to transfer energy between two objects through electromagnetic induction. Energy is sent through an inductive coupling to an electrical device, which can then use that energy to charge batteries or run the device.

The present invention may further utilize a charge controller 14. The charge controller 14 is secured within the bag 26, 30. The charge controller 14 may include a global positioning system (GPS). The global position system (GPS) may send GPS coordinates of the bag 26, 30 a smart device via an application loaded on the smart device. The smart device may be a smartphone, a tablet and the like. Therefore, if the bag 26, 30 is lost or stolen, the user may find the bag's whereabouts.

The battery 18 is electrically connected to the charge controller 14 by a first cord 22 and the charge controller 14 is electrically connected to the charging station 10 by a second cord 12. In certain embodiments, the charge controller 14 includes at least one universal serial bus (USB) port 16 and the battery 18 includes at least one USB port 24. For example, each of the charge controller 14 and the battery may include multiple USB ports 16, 24 to connect with additional devices. In such embodiments, the first cord 22 and the second cord 12 are each USB cords.

The battery 18 of the present invention is a portable battery pack that provides power to either the charging station 10 alone or to the charge control 14 and the charging station 10. In certain embodiments, the battery 18 may include a lithium ion charged battery with a 20000 mAh battery power source and the like. However, the present invention is not limited to the above-mentioned battery, and may include any battery that is capable of recharging a mobile device 34. In certain embodiments, the battery 18 may include a digital screen 20 which displays the amount of charge level of battery life. For example, the digital screen 20 may be a light emitting diode display, plasma display and the like.

In certain embodiments, the pocket 28 may include a radio frequency identification shield. The radio frequency identification shield may protect the user from RFID skimming, which is a form of digital theft. The radio frequency identification shield may include a metal sheet, such as aluminum foil, embedded within and surrounding the pocket 28.

The bag 26, 30 of the present invention may include a gym bag, travel bag, briefcase, purse/tote 26, a backpack 30 and the like. The backpack 30 includes a pair of shoulder straps attached to and extending from a rear side of the backpack 30. The purse/tote 26 includes at least one handle having ends attached to top portions of sides of the purse/tote 26, 30.

It should be understood, of course, that the foregoing relates to exemplary embodiments of the invention and that modifications may be made without departing from the spirit and scope of the invention as set forth in the following claims.

What is claimed is:

1. A wireless charging apparatus comprising:
a bag comprising an internal compartment, wherein a pocket sized to receive a mobile device is formed within the internal compartment;
a charging station secured within the bag adjacent to the pocket, wherein the charging station is operable to charge the mobile device when the mobile device is disposed within the pocket; and
a battery secured within the bag and providing power to the charging station.

2. The wireless charging apparatus of claim 1, further comprising a charge controller comprising a global position system secured within the bag.

3. The wireless charging apparatus of claim 2, wherein the battery is electrically connected to the charge controller by a first cord and the charge controller is electrically connected to the charging station by a second cord.

4. The wireless charging apparatus of claim 3, wherein the charge controller and the battery each comprise a universal serial bus port, wherein the first cord and the second cord are each universal serial bus port cords.

5. The wireless charging apparatus of claim 1, wherein the battery comprises a digital display showing an amount of charge of the battery.

6. The wireless charging apparatus of claim 1, wherein the charging station comprises inductive charging.

7. The wireless charging apparatus of claim 1, wherein the pocket further comprises a radio frequency identification shield.

8. The wireless charging apparatus of claim 7, wherein the radio frequency identification shield comprises a metal sheet surrounding the pocket.

9. The wireless charging apparatus of claim 1, wherein the bag is a backpack comprising a pair of shoulder straps attached to and extending from a rear side of the backpack.

10. The wireless charging apparatus of claim 1, wherein the bag is a purse comprising at least one handle comprising ends attached to top portions of sides of the purse.
